(19) United States
(12) Patent Application Publication
(10) Pub. No.: US 2024/0201414 A1
(43) Pub. Date: Jun. 20, 2024

(54) WATER SATURATION AND CATION EXCHANGE CAPACITY FROM LOGGING-WHILE-DRILLING ELECTROMAGNETIC MEASUREMENTS

(71) Applicants: Schlumberger Technology Corporation, Sugar Land, TX (US); Saudi Arabian Oil Company, Dhahran (SA)

(72) Inventors: Ping Zhang, Beijing (CN); Gong Li Wang, Sugar Land, TX (US); Wael Abdallah, Dhahran (SA); Dean Homan, Damon, TX (US); Shouxiang Ma, Dhahran (SA)

(21) Appl. No.: 18/553,628

(22) PCT Filed: Apr. 28, 2021
(86) PCT No.: PCT/US2021/029692

§ 371 Date: Oct. 2, 2023

(51) Int. Cl. G01V 3/38; E21B 44/00; E21B 49/00; G01V 3/30

(52) U.S. Cl. CPC G01V 3/38; E21B 44/00; E21B 49/00; G01V 3/30; E21B 2200/20

(57) ABSTRACT

A method for characterizing a subterranean formation is provided that involves obtaining resistivity log data measured by a logging-while-drilling electromagnetic tool operated while drilling a wellbore that traverses the subterranean formation, and calculating at least one of a first data value representing water saturation of the subterranean formation and a second data value representing cation exchange capacity (CEC) of the subterranean formation from the resistivity log data. In embodiments, the method can further involve storing at least one of the first data value and the second data value in computer memory, and/or outputting at least one of the first data value and the second data value as part of a log for well placement, formation evaluation. geological modeling, or reservoir management. The first data value and/or the second data value can also be used for geo-steering the drilling of the wellbore.

### FIELD

The subject disclosure generally relates to the field of evaluating reservoirs in the oil and gas industry. More particularly, the subject disclosure relates to using logging-while-drilling electromagnetic measurement data, such as resistivity, to calculate formation water saturation and formation rock cation exchange capacity.

### BACKGROUND

For log interpretation of shaly sand reservoirs, there are several models available to characterize the formation; rocks and fluids. Commonly used models include the Waxman and Smits (W-S) model, and dual water (D-W) model of Clavier et al., 1984. See, Waxman and Smits, Electrical conductivities in oil-bearing shaly sands, SPEJ 8(2), 107-122, (1968); and Clavier, et al. The theoretical and experimental bases for the dual water model for the interpretation of shaly sands, SPE 6859, 1977 ATCE, SPEJ Apr. (1984). Although these models have successes in the interpretation of electric-log responses of shaly sand homogeneous reservoir rocks, the models are not explicit in their predictions of electrical conductivity with respect to rock structure, spatial fluid distribution in the pore space, wettability, or clay mineral distribution. See, Devarajan, S., Toumelin, E., Torres-Verdin, C., Thomas, E. C., “Pore-scale analysis of the Waxman-Smits shaly sand conductivity model”, SPWLA, Jun. 4-7 (2006). All of these models require information about formation water salinity (R_{w}) and cation exchange capacity (CEC) as demonstrated in the section below.

The Archie model described in Archie, G. E., the Electrical Resistivity Log as an Aid in Determining Some Reservoir Characteristics. Trans. of AIME 146 (1), 1942, provides a fundamental empirical correlation for interpreting resistivity measurements as follows:

$$\frac{1}{{R}_{t}} = {ϕ}^{m} {S}_{w}^{n} ( \frac{1}{{R}_{w}} ) \qquad Eqn . ( 1 )$$

where R_{w} is formation true resistivity, ϕ is formation water resistivity, S_{w} is water saturation, n is saturation exponent, ϕ is reservoir total porosity, and m is porosity exponent. This model is referred to as the Archie model.

When clay minerals are present, the W-S model can be applied. The W-S model is characterized by the following equation:

$$\frac{1}{{R}_{t}} = {ϕ}^{{m}^{*}} {S}_{w}^{{n}^{*}} ( \frac{1}{{R}_{w}} + \frac{B {Q}_{v}}{{S}_{w}} ) \qquad Eqn . ( 2 )$$

where, m* and n* are Archie porosity and saturation exponents for shaly sands and apply to the total pore volume, and B is specific cation conductance in (ohm⁻¹⁾/(meq/ml).

The parameter Qv is related to cation exchange capacity (CEC) per unit pore volume as follows:

$${Q}_{v} = {ρ}_{g} C E C \frac{1 - ϕ}{ϕ} \qquad Eqn . ( 3 )$$

where CEC is in meq/gram of dry rock, ϕ_{g} is grain density in g/cc, and ϕ is total porosity. In clean zones without clay, Qv=0, m*=m, n*=n, and the W-S model of Eqn. (2) becomes the Archie model of Eqn. (1).

The D-W model is based on the double layer effect close to the grain surface, and given by:

$$\frac{1}{{R}_{f}} = {ϕ}^{{m}_{0}} {S}_{w}^{{n}_{0}} [ \frac{1}{{R}_{w F}} + \frac{{S}_{w B}}{{S}_{w}} ( \frac{1}{{R}_{w B}} + \frac{1}{{R}_{w F}} ) ] \qquad Eqn . ( 4 )$$

where R_{wB} is clay bound water resistivity, R_{wF} is free formation water resistivity, and S_{wB} is clay bound water saturation with respect to total pore volume.

S_{wB} can be estimated using the HSK model proposed by Shirley et al., “Bound Water in Shaly Sands—Its Relation to Qv and Other Formation Properties,” The Log Analyst 20 (3): 3, 1979, as follows:

$${S}_{w B} = {Q}_{v} ( \frac{{a}_{1}}{\sqrt{{C}_{N a C l}}} + {a}_{2} ) \qquad Eqn . ( 5 )$$

where a₁ and a₂ are constants, and C_{NaCl} is NaCl concentration in equivalent/liter. In clean zones without clay, S_{wB}=0, m₀=m, n₀=n, and the D-W model of Eqn. (4) becomes the Archie model of Eqn. (1).

CEC is typically measured in the laboratory by potentiometric titration experimental methods. See Meier, L. P., and G. Kahr (1999), Determination of the cation exchange capacity (CEC) of clay minerals using the complexes of copper (II) ion with triethylenetetramine and tetraethylenepentamine, Clays Clay Miner., 47(3), 386-388. Uncertainties associated with these experimental methods are many, including how representative of the laboratory sample analyzed to downhole conditions, and details of the laboratory sample preparation and analysis such as the degree to which the clay mineral geometry is altered by the disaggregation of the core sample, which can be enhanced by grinding to grain size particles. See Huff, G. F. 1987. A Correction for the Effect of Comminution on the Cation Exchange Capacity of Clay-Poor Sandstones. SPE Form Eval 2 (3): 338-344. SPE-14877.

Formation water salinity or formation water resistivity R_{w} is normally obtained by water analysis in a laboratory. See, Ma, S., Hajari, A., Berberian, G. & Ramamoorthy, R: “Cased-Hole Reservoir Saturation Monitoring in Mixed Salinity Environments—A New Integrated Approach,” SPE 92426, 2005 MOES. Without a robust continuous in situ measurement, formation water salinity is often assumed to be constant within the hydrocarbon column, and usually there is little data regarding R_{w} other than from formation sampling. In several cases in which the R_{w} distribution has been studied in depth, it was found to vary in systematic ways within the hydrocarbon column. See, McCoy, D. and Fisher, T. E. 1997. Water-Salinity Variations in the Ivishak and Sag River Reservoirs at Prudhoe Bay. SPE Res Eng 12 (1): 37-44. SPE-28577; Rathmell, J. J ., Bloys, J. B., Bulling, T. P. et al. 1995. Low Invasion, Synthetic Oil-Base Mud Coring in the Yacheng 13-1 Gas Reservoir for Gas-in-Place Calculation. Presented at the International Meeting on Petroleum Engineering, Beijing, China, 14-17 Nov. 1995. SPE-29985; and Rathmell, J., Atkins, L. K., and Kralik, J. G. 1999. Application of Low Invasion Coring and Outcrop Studies to Reservoir Development Planning for the Villano Field. Presented at the Latin American and Caribbean Petroleum Engineering Conference, Caracas, Venezuela, 21-23 Apr. 1999. SPE-53718.

Recent efforts have been made to derive this salinity information from special wireline logs. See, Ma, S., Pfutzer, H., Hajari, A., Musharfi, N., Saldungaray, P. & Azam, H: “Resolving Mixed Salinity Challenge with a Methodology Developed from Pulsed Neutron Capture Gamma Ray Spectral Measurements,” SPE 170608, SPE ATCE, Amsterdam, Oct. 27-29, 2014.

It is desirable to have both CEC and R_{w} calculated from downhole measurements continuously across the reservoir at reservoir conditions, and it is advantageous if these fundamental reservoir properties can be extracted from advanced processing of existing measurements. For example, U.S. Pat. No. 10,215,876, commonly assigned to assignees of the subject disclosure, describes the CEC and R_{w} from the inversion of wireline array induction measurements.

Nowadays, the majority of development wells are drilled highly deviated or horizontally. Many wells are horizontal multi-lateral wells in order to maximize well productivity through maximized reservoir contacts. However, wireline array induction measurements ae often not performed in highly deviated and/or horizontal wells.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to some embodiments, a method is provided that characterizes a subterranean formation. The method involves obtaining resistivity log data measured by a logging-while-drilling electromagnetic tool operated while drilling a wellbore that traverses the subterranean formation, and calculating at least one of a first data value representing water saturation of the subterranean formation and a second data value representing cation exchange capacity (CEC) of the subterranean formation from the resistivity log data.

In embodiments, the method can further involve storing at least one of the first data value and the second data value in computer memory, and/or outputting at least one of the first data value and the second data value as part of a log for well placement, formation evaluation, geological modeling, or reservoir management. The first data value and/or the second data value can also be used for geo-steering the drilling of the wellbore.

In embodiments, the first data value representing water saturation of the subterranean formation can be calculated using a relationship involving an in-phase conductivity component, a quadrature-phase conductivity component, and a first plurality of formation parameters. The in-phase conductivity component and the quadrature-phase conductivity component can be determined by inversion of the resistivity log data measured by the logging-while-drilling electromagnetic tool.

In embodiments, the first plurality of formation parameters can include water conductivity. The water conductivity can be calculated using water salinity and formation temperature, which can be determined using at least one formation water sample.

In embodiments, the first plurality of formation parameters can further include an electric formation factor and a parameter (e.g., parameter K as described herein) based on grain density, counter-ion mobility, and fraction of counter-ion.

In embodiments, the first plurality of formation parameters can further include an additional parameter (e.g., parameter Q as described herein) based on grain density, counter-ion mobility, and electric formation factor.

In embodiments, the second data value representing CEC of the subterranean formation can be calculated using a relationship involving a quadrature-phase conductivity component, the first data value representing water saturation of the subterranean formation, and a second plurality of formation parameters. The quadrature-phase conductivity component can be determined by inversion of the resistivity log data measured by the logging-while-drilling electromagnetic tool.

In embodiments, the second plurality of formation parameters can include a parameter (e.g., parameter K as described herein) based on grain density, counter-ion mobility, and fraction of counter-ion.

In embodiments, the calculation of the at least one of the first data value and the second data value can be based on knowledge about the subterranean obtained from laboratory measurements and/or measurement logs.

In embodiments, the subterranean formation can comprise clay, such as a shaly-sand formation.

In embodiments, the resistivity log data can include attenuation and phase-shift measurements performed by the logging-while-drilling electromagnetic tool. For example, the attenuation and phase-shift measurements can be performed at frequencies in the KHz to MHz range.

In embodiments, the logging-while-drilling electromagnetic tool can be part of a bottom hole assembly that includes a rotary drill bit. For example, the logging-while-drilling electromagnetic tool can be a propagation type resistivity tool.

In embodiments, the resistivity log data can be obtained at different depths in the wellbore in order to investigate different parts of the subterranean formation that is traversed by the wellbore while drilling the wellbore. The method can further involve processing the resistivity log data at respective depths in order to calculate at least one of the first data value and the second data value at the different depths.

The logging-while drilling resistivity log data is commonly acquired for well placement and formation evaluation. Extracting additional formation characteristics such as water saturation and CEC from such logging-while drilling resistivity log data can improve and aid in well placement, formation evaluation, geological modeling, or reservoir management. It can also improve geo-steering of the well drilling operation.

Further features and advantages of the subject disclosure will become more readily apparent from the following detailed description when taken in conjunction with the accompanying drawings.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 depicts an interfacial polarization of clay minerals with an electrical double layer;

FIG. 2A is a schematic diagram of a wellsite and a drilled well that embodies a logging-while-drilling (LWD) system according to the present disclosure;

FIG. 2B shows a propagation-type resistivity tool that is part of the bottom-hole

assembly of the LWD system of FIG. 2A;

FIGS. 3A-3B, collectively, is a flow chart that illustrates a workflow according to

the present disclosure, which estimates formation water saturation (S_{w}) and cation exchange capacity (CEC) from LWD resistivity tool measurements; and

FIG. 4 is a schematic diagram of a computer system.

### DETAILED DESCRIPTION

The particulars shown herein are by way of example and for purposes of illustrative discussion of the examples of the subject disclosure only and are presented in the cause of providing what is believed to be the most useful and readily understood description of the principles and conceptual aspects of the subject disclosure. In this regard, no attempt is made to show structural details in more detail than is necessary, the description taken with the drawings making apparent to those skilled in the art how the several forms of the subject disclosure may be embodied in practice. Furthermore, like reference numbers and designations in the various drawings indicate like elements.

In a subterranean formation, dielectric permittivity is mainly caused by induced polarization (IP). Under an external electromagnetic (EM) field, both electrical conduction (due to charge carries) and induced polarization (due to ions) co-exist, and the measured EM field is influenced by both effects. Electrical conduction describes the movement of the charge carried under the influence of the external EM field. This is a well-understood phenomenon and can be described by Ohm's law.

Induced polarization (IP) can be observed in porous media containing clay materials (such as shaly sands). Clay minerals can be grouped, based on molecular structure and composition, into four commonly encountered and representative clay types: kaolinite, illite, chlorite and smectite. Although each clay type impacts formation conductivity differently, the fundamental mechanism is similar. When the surface of a clay mineral grain is exposed to electrolytes, it acquires charges due to ionic adsorption, protonation/deprotonation of the hydroxyl groups, and dissociation of other potentially active surface groups and becomes conductive. In the presence of an external electromagnetic (EM) field, these surface charges from electric dipoles cause induced polarization (IP) effects. See Leroy et al., “A triple layer model of the surface electrochemical properties of clay minerals”, Journal of Colloid and Interface Science, 270, 371-380, 2004. The strength of the IP effects is regulated by permittivity of the porous media (formation rock).

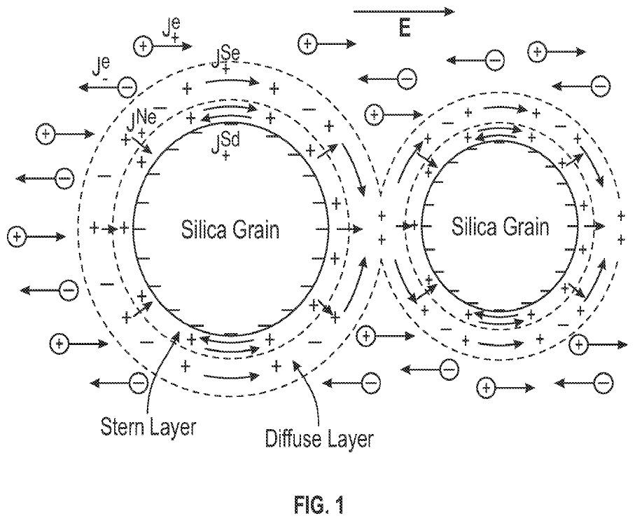

The polarization of clay particles is mostly due to charge accumulation and movements at host-inclusion interfaces. The most common theory to describe this induced polarization is the electrical double layer shown in FIG. 1. At the surface of the clay particles, both Stern and diffuse layers are formed due to charge absorptions and movements. In the presence of an externally applied electric field, the double layer develops a counter ion cloud and diffused-charge distribution around host-inclusion interfaces. Dynamics of accumulation/depletion of charge concentrations around host-inclusion interfaces influence the magnitude and phase of the electromagnetic response of a porous media such as reservoir formation rock containing clay minerals.

The effect of IP can be widely observed from electromagnetic (EM) surveys conducted on porous media. The commonly measured downhole resistivity logs are also impacted by IP effects; thus, resistivity logs can be used to estimate dielectric permittivity. More specifically, in a subterranean formation containing porous media (reservoir formation rock) and formation fluids (water, oil, and/or gas), application of an externally applied electric field results in electric conduction (migration of charge) and interfacial polarization (IP). The conduction current and IP effects can be characterized by formation conductivity and dielectric permittivity, which can be described by a complex conductivity:

$$σ = {σ}^{R} + i {σ}^{I} \qquad Eqn . ( 6 )$$

where σ^{R} is the in-phase component, and σ^{I} is the quadrature component of the total conductivity σ, respectively. As used herein the terms “in-phase” and “real” are used interchangeably, and the terms “quadrature” and “imaginary” are used interchangeably. Conductivity is one over resistivity in Eqs. 1-4.

For a porous media containing clay minerals, this total conductivity o depends on conductivity of pore fluid, saturation, ion mobility and CEC of clay inclusions. In particular, the in-phase and quadrature components have different relationship with these parameters as follows.

More specifically, the in-phase component σ^{R} can be related to conductivity of pore fluid, saturation, ion mobility and CEC of clay inclusions as follows:

$${σ}^{R} = \frac{{S}_{w}^{n}}{F} [ {σ}_{w} + \frac{2 m β + {ρ}_{g} C E C}{3} ( F - 1 ) ] \qquad Eqn . ( 7 )$$

where σ_{w} is formation water conductivity (1/R_{w}), ρ_{g} is grain density, β₊ is mobility of the counter-ion, F is electric formation factor, F=ϕ^{-m}₀, S_{w} is water saturation, n is saturation exponent, m is cementation exponent for shaly formation and CEC is cation exchange capacity.

The quadrature component Υ¹ can be related to conductivity of pore fluid, saturation, ion mobility and CEC of clay inclusions as follows:

$${σ}^{I} = - \frac{2}{3} {β}_{+}^{s} f {ρ}_{g} {S}_{w}^{n - 1} C E C \qquad Eqn . ( 8 )$$

where B₊^{S} is mobility of the counter-ion within Stern layer, and f is fraction of counter-ion in the Stern layer.

Among all of the parameters related to the in-phase component σ^{R} and the quadrature component σ¹ of the total conductivity σ, the water saturation S_{w} and CEC are the key petrophysical parameters which can be used to calculate the oil reserve and to identify clay types in the reservoir rocks. In general, it will be very difficult to estimate S_{w} and CEC without detailed knowledge of other parameters. In practical applications, however, if we consider typical clay minerals with pore water solution as an electrolyte of NaCl, most parameters have either well defined values from laboratory experiments or they are within narrow variation range. This will allow for calculation of S_{w} and CEC values using LWD resistivity logs with following steps:

First, Eqns. (7) and (8) can be rewritten as:

$${σ}^{R} = \frac{{S}_{w}^{n}}{F} [ {σ}_{w} + \frac{Q {σ}^{I}}{K {S}_{w}^{n - 1}} ] , and \qquad Eqn . ( 9 )$$

$$CEC = \frac{{σ}^{I}}{K {S}_{w}^{n - 1}} \qquad Eqn . ( 10 )$$

$$where the parameter K = - \frac{2}{3} {β}_{+}^{s} f {ρ}_{g} , and \qquad Eqn . ( 11 )$$

$$the parameter Q = \frac{2}{3} m {β}_{+} {ρ}_{g} ( F - 1 ) . \qquad Eqn . ( 12 )$$

For typical clay minerals with pore water of an electrolyte of NaCl, the β₊^{s} (25° C., Na⁺) of Eqn. (11) can be set to 1.5×10⁻¹⁰ m²s¹V⁻¹ and the β₊(25° C., Na⁺) of Eqn. (12) can be set to 5.2×10⁻⁸ m²s⁻¹V⁻¹. For most clay minerals, f of Eqn. (11) can be defined within a narrow range (0.85 to 0.95), a typical value is f-0.90. The grain density ρ_{g} of Eqn. (11) can be acquired through density log. For example, a typical clay mineral has a grain density ρ_{g}=2650 kg m⁻³. See, Revil, A. 2012, Spectral induced polarization of shaly sands: Influence of the electrical double layer: Water resources research, Vol 48, W02517. The m and n values of Eqns. (9), (10) and (12) can be set to m=2 and n=2, which are typical values for most petrophysical calculations. The formation factor F is a function of porosity which can be acquired through many traditional logs, such as density and neutron logs.

Second, water samples can be obtained from the drilled wellbore as is common practice. From the water samples, one can measure water salinity C_{w}. Formation temperature T can be measured from downhole sensors. Then, water conductivity σ_{w} can be calculated from the water salinity C_{w} and formation temperature T as follows:

$${σ}_{w} = \frac{{C}_{w}^{0.955}}{A ( 0.0123 {C}_{w}^{0.955} + 3647.5} , and \qquad Eqn . ( 13 )$$

$$A = \frac{82}{1.8 T + 39} . \qquad Eqn . ( 14 )$$

The calculations of Eqns. (13) and (14) are described in Zhang, J., Hu, Q. and Liu, Z. 1999: Estimation of true formation resistivity and water saturation with time-lapse induction logging method, The log analysis, Vol 40, No. 2, P. 138-148.

Third, attenuation and phase-shift measurements can be performed while drilling the wellbore by a LWD electromagnetic resistivity tool, and such attenuation and phase-shift measurements can be inverted to solve for the in-phase component σ^{R} and the quadrature component σ_{I} of Eqns. (9) and (10).

Finally, the in-phase component σ^{R} and the quadrature component σ^{I} derived from the attenuation and phase-shift measurements of the LWD electromagnetic resistivity tool together with the water conductivity σ_{w} calculated from Eqns. (13) and (14) and the parameters K and Q calculated from Eqns. (11) and (12) can be used as inputs to solve Eqns. (9) and (10) to calculate data values for the water saturation S_{w} and CEC.

The above-mentioned methodology provides a practical and efficient way to estimate water saturation S_{w} and CEC values, which are critical parameters in well placement, formation evaluation, geological modeling, and reservoir management. In embodiments, the methodology can employ attenuation and phase-shift measurements of the LWD electromagnetic resistivity tool at frequencies in the KHz to MHz range.

Advantageously, the water saturation S_{w} and CEC values can be from downhole measurements continuously across the reservoir (e.g., shaly sand reservoir) at reservoir conditions. Furthermore, these fundamental reservoir properties can be extracted from the LWD electromagnetic resistivity measurements that are commonly acquired for well placement and formation evaluation. Extracting additional formation characteristics such as CEC from the LWD electromagnetic resistivity measurements can also help improve geo-steering in well drilling and enhance formation evaluation.

According to some embodiments, details of how to use the attenuation and phase-shift measurements of an LWD electromagnetic resistivity tool to estimate water saturation and CEC values are described.

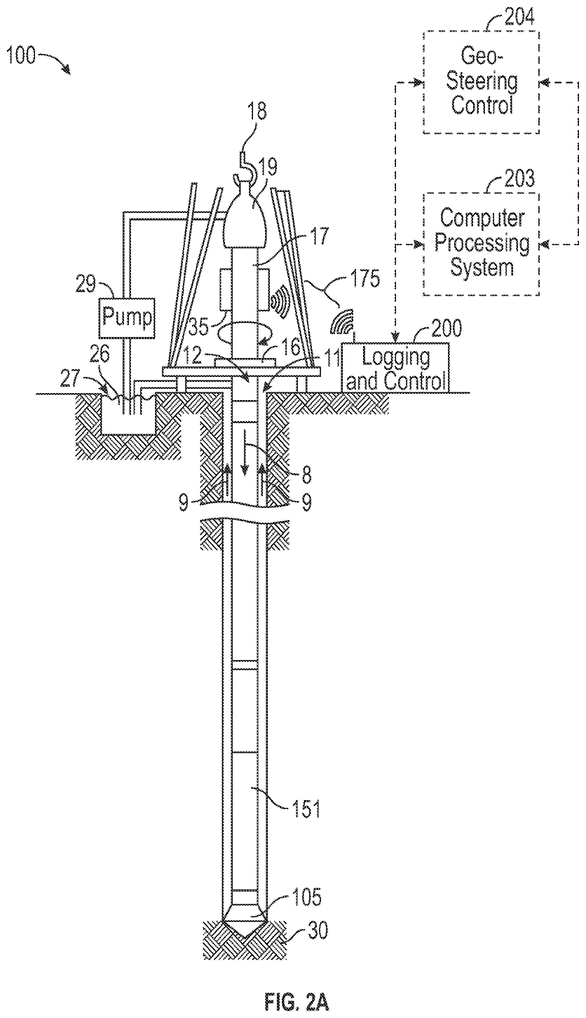

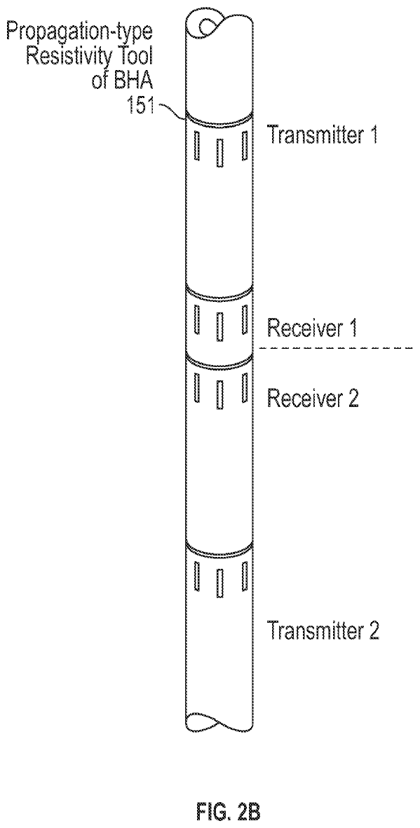

FIG. 2A illustrates a while-drilling wellsite environment in which the disclosed methods and workflows can be employed to process acquired measurements. The wellsite can be onshore or offshore. In this system, a borehole or wellbore 11 is formed in a subsurface formation reservoir 30 by directional rotary drilling. A drill string 12 is suspended within the borehole 11 and has a bottom hole assembly 151 which includes a drill bit 105 at its lower end. The surface system includes platform and derrick assembly 10 positioned over the borehole 11. The assembly 10 includes a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, and attached to a traveling block (also not shown), through the kelly 17 and a rotary swivel 19 which permits rotation of the drill string relative to the hook. As is well known, a top drive system could alternatively be used.

In this example embodiment, the surface system further includes drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this well-known manner, the drilling fluid lubricates the drill bit 105 and carries formation cuttings up to the surface as it is returned to the pit 27 for recirculation.

As is known in the art, sensors may be provided about the wellsite to collect data, preferably in real time, concerning the operation of the wellsite, as well as conditions at the wellsite. For example, such surface sensors may be provided to measure parameters such as standpipe pressure, hook load, depth, surface torque, rotary rpm, among others.

The bottom hole assembly (BHA) 151 of the illustrated embodiment includes at least one LWD tool and a rotary steerable system that controls the drilling direction of the drill bit. The LWD tool can be housed in a special type of drill collar as is known in the art. The LWD tool includes capabilities for measuring and storing electromagnetic response data that is sensitive to resistivity profile of the formation in the vicinity of the BHA 151. The BHA 151 can also include MWD module(s) housed in a special type of drill collar as is known in the art. The MWD module(s) can include capabilities for measuring, processing, and storing information that characterizes position and direction of the drill string 12 and the drill bit of the BHA 151 as well as other drilling measurements, such as a weight-on-bit, torque, and shock and/or vibration. As used herein, the term “module” as applied to MWD module(s) is understood to mean either a single tool or a suite of multiple tools contained in a single modular device.

The BHA 151 also includes a downhole telemetry subsystem that communicates data signals and control signals between the components of the BHA 151 (including the LWD tool) and a surface-located logging and control unit 200 via electronic subsystem 35. The downhole telemetry subsystem can employ a variety of telemetry methods, such as wired telemetry methods (e.g., drill pipe that incorporate telemetry cables or fiber optic cables) and wireless telemetry method (e.g., mud-pulse telemetry methods, electromagnetic telemetry methods, and acoustic telemetry methods). The downhole telemetry subsystem can also supply electrical power supply signals generated by a surface-located power source for supply to the components of the BHA 151. The BHA 151 can also include a power supply transformer/regulator for transforming the electric power supply signals supplied by the surface-located power source to appropriate levels suitable for use by the components of the BHA 151. In alternate embodiments, the BHA 151 can include an apparatus for generating electrical power for supply to the components of the BHA, such as a mud turbine generator powered by the flow of the drilling fluid. Other power and/or battery systems may be employed.

The wellsite of FIG. 2A can also include the surface-located logging and control unit 4 that interfaces to computer processing system 203 via data communication links (shown as bidirectional dotted lines with arrows). A control module 204 (labeled “geo-steering control”) can interface to the logging and control unit 200 and to the computer processing system 203 via data communication links (shown as bidirectional dotted lines with arrows) for geo-steering and geo-stopping applications as described herein. The data communication links between the surface-located components can utilize wired and/or wireless connection via one or more communication lines. The communication topology between these surface-located components can be point-to-point, point-to-multipoint or multipoint-to-point. The wired connection(s) can employ a variety of cable types or wires using diverse wired protocols (serial, wired Ethernet, fiber channel, etc.). The wireless connection(s) can employ a variety of diverse wireless protocols (such as IEEE 802.11, Bluetooth, Zigbee or any non-standard RF or optical communication technology).

The computer processing system 203 can be configured to perform the methods and workflows as described herein. The control module 204 can communicate with the logging and control unit 200 to control the position and orientation of the BHA 151 as determined by the operation of the computer processing system 203.

In embodiments, the BHA 151 can include a rotary steerable system and drill bit 212. The rotary steerable system can be used to dynamically adjust the direction of the drilling performed by the drill bit 212 under commands communicated from the geo-steering control module 204 via the logging and control unit 4 and the telemetry subsystem of the BHA 151. The method used by the rotary steerable system to dynamically adjust the direction of the drilling can generally fall into two categories, these being “push-the-bit” or “point-the-bit”. Push-the-bit systems use pads on the outside of the tool which press against the wellbore thereby causing the bit to press on the opposite side causing a direction change. Point-the-bit systems cause the bit direction to change relative to the rest of the tool by bending the main shaft running through it.

In embodiments, the LWD tool of the BHA 151 can include a propagation-type resistivity tool as shown in FIG. 2B. The propagation-type resistivity tool broadcasts a high frequency electromagnetic wave (typically in the frequency range of KHz to MHz) and measures the attenuation and phase shift differences between voltages induced at two receivers. The phase shift and attenuation can be transformed into apparent resistivity measurements, where phase shift apparent resistivities read typically shallower than the attenuation apparent resistivity measurements. In one embodiment, the propagation-type resistivity tool can be realized by the compensated dual resistivity (CDR) tool, which has two transmitters symmetrically arranged around two receivers as shown in FIG. 2B. Each transmitter alternately broadcasts a 400 kHz and 2 MHz electromagnetic waves. A propagation measurement is made by taking the difference between the phases (phase shift) and amplitudes (attenuation) of the voltages recorded at the two receivers. Attenuation increases as a function of increasing conductivity, while the wavelength decreases as conductivity increases. Thus, the two measurements are monotonically increasing with formation conductivity and can be used to generate resistivity logs. The phase shift and attenuation measurements generated by the upper transmitter between the two receivers, and by the lower transmitter between the two receivers, are averaged to symmetrize the tool response. This averaging is known as borehole compensation because it also reduces the effect of borehole rugosity.

According to some embodiments, one or more other LWD tools such as a gamma ray tool, a density tool, a neutron porosity tool, and/or a sonic tool, can be integrated into the BHA 151 and operated to performed measurements of the nearby formation as the wellbore is being drilled.

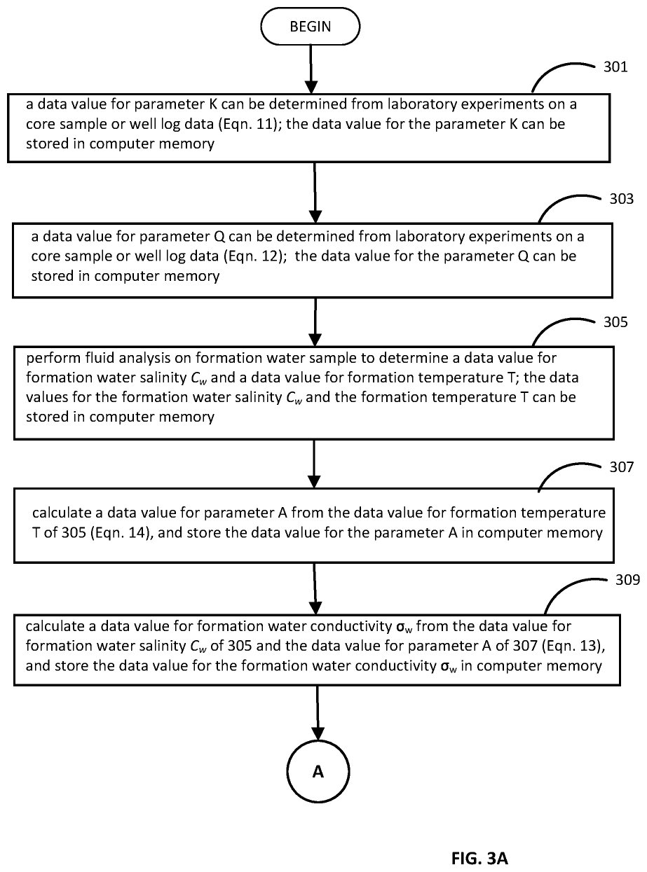

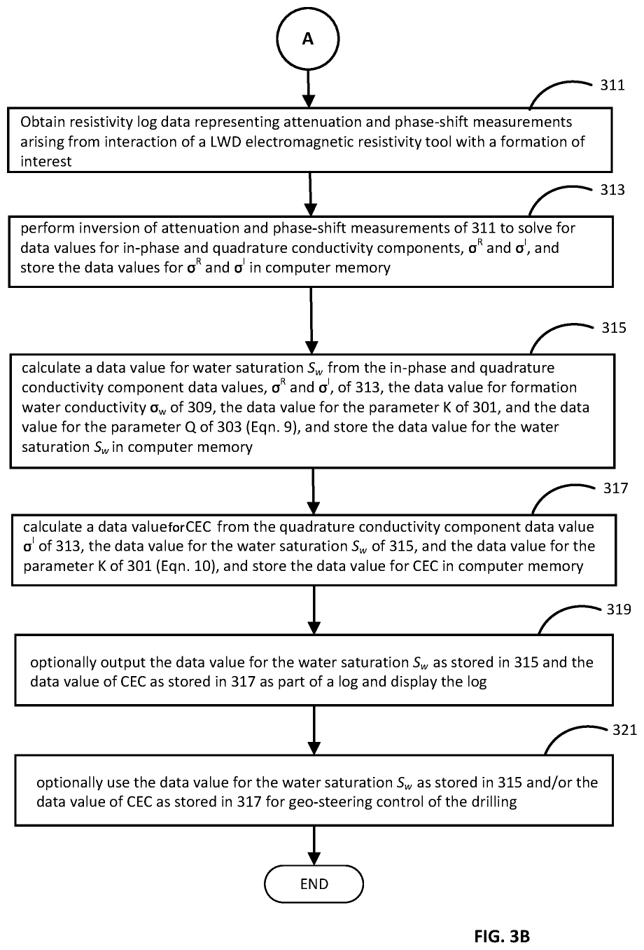

FIGS. 3A and 3B, collectively, is a flow chart illustrating aspects of estimating formation water saturation and CEC based on resistivity log data obtained by an LWD electromagnetic resistivity tool and other knowledge according to some embodiments.

In block 301, a data value for parameter K can be determined from laboratory experiments on a core sample or well log data, e.g., Eqn. 11. The data value for the parameter K can be stored in computer memory. The core sample or well log data can be obtained from a well that traverses a formation of interest or from another similar formation.

In block 303, a data value for parameter Q (Eqn. 12) can be determined from laboratory experiments on a core sample or well log data. The data value for the parameter Q can be stored in computer memory. The core sample or well log data can be obtained from a well that traverses a formation of interest or from another similar formation.

In block 305, fluid analysis can be performed on formation water sample to determine a data value for formation water salinity C_{w}. A data value for formation temperature T can be obtained while drilling with temperature sensors (change the flow chart description also). The data values for the formation water salinity C_{w} and the formation temperature T can be stored in computer memory. The formation water sample can be taken from a well that traverses the formation of interest or from another similar formation. Furthermore, the formation water sample can be obtained from a depth or location in the formation of interest that corresponds to the depth or location of the core sample of blocks 301 and 303. The fluid analysis can be formed by laboratory experiments on fluid samples taken from the formation and carried by an LWD tool to the surface for transport to the laboratory. Alternatively, the fluid analysis can be performed by downhole fluid analysis as part of an LWD tool.

In block 307, a data value for parameter A can be calculated from the data value for formation temperature T of 305 (Eqn. 14), and the data value for the parameter A can be stored in computer memory.

In block 309, a data value for formation water conductivity ow can be calculated from the data value for formation water salinity C_{w} of 305 and the data value for the parameter A of 307 (Eqn. 13), and the data value for the formation water conductivity ow can be stored in computer memory.

In block 311, resistivity log data representing attenuation and phase-shift measurements arising from interaction of an LWD electromagnetic resistivity tool with the formation of interest is obtained. In embodiments, the attenuation and phase-shift measurements can be obtained from a depth or location in the formation of interest that corresponds to the depth or location of the core sample of blocks 301 and 303. In embodiments, the LWD electromagnetic resistivity tool can be an LWD propagation-type resistivity tool (e.g., FIGS. 2A and 2B) or other LWD resistivity tool.

In block 313, an inversion of the attenuation and phase-shift measurements of 311 is performed to solve for data values for in-phase and quadrature conductivity components, σ^{R} and σ^{I}, and the data values for σ^{R} and σ^{I} can be stored in computer memory. Examples of such inversion operations are described in U.S. Patent Publ. No. 2010/0324826, commonly assigned to assignee of the subject disclosure, and herein incorporated by reference in its entirety. Other suitable inversion operations can also be used.

In block 315, a data value for water saturation S_{w} can be calculated from the in-phase and quadrature conductivity component data values σ^{R} and σ^{I} of 313, the data value for formation water conductivity σ_{w} of 309, the data value for the parameter K of 301, and the data value for the parameter σ_{w} of 303 (Eqn. 9). The data value for the water saturation S_{w} can be stored computer memory.

In block 317, a data value for CEC can be calculated from the quadrature

conductivity component data value σ^{I} of 313, the data value for the water saturation S_{w} of 315, and the data value for the parameter K of 301 (Eqn. 10). The data value for CEC can be stored in computer memory.

In optional block 319, the data value for the water saturation S_{w} as stored in 315 and the data value of CEC as stored in 317 can be output as part of a log displayed to one or more users. The log can be used for well placement, formation evaluation, geological modeling, or reservoir management.

In optional block 321, the data value for the water saturation S_{w} as stored in 315 and/or the data value of CEC as stored in 317 can be used for geo-steering control of the drilling operations, such as those described above in paragraph [0056].

Note that the downhole measurements of the workflow can be performed at different depths in the wellbore in order to investigate different parts of the subterranean formation that is traversed by the wellbore while drilling the wellbore, and the processing of the workflow can be repeated for the corresponding downhole measurements at the respective depths in order to accurately characterize the formation rock at the measured depths.

Since the resistivity log data is commonly obtained while drilling almost all production wells, the methodology described herein provides a practical and efficient way to estimate water saturation and CEC values, which are parameters used in formation evaluation, reservoir surveillance and reservoir management. Thus, according to some embodiments, if we consider typical clay minerals with pore water solution is an electrolyte of NaCl, then the described techniques can be used to estimate CEC (and thus clay typing for different clays have different CECs), and formation water saturation using measured resistivity log data.

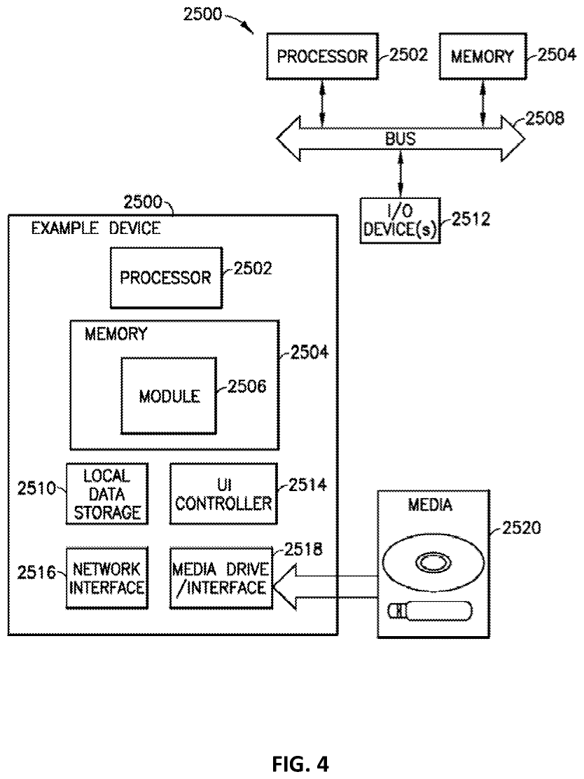

FIG. 4 illustrates an example device 2500, with a processor 2502 and memory 2504 that can be configured to implement various embodiments of the workflow described herein. Memory 2504 can also host one or more databases and can include one or more forms of volatile data storage media such as random-access memory (RAM), and/or one or more forms of nonvolatile storage media (such as read-only memory (ROM), flash memory, and so forth).

Device 2500 is one example of a computing device or programmable device and is not intended to suggest any limitation as to scope of use or functionality of device 2500 and/or its possible architectures. For example, device 2500 can comprise one or more computing devices, programmable logic controllers (PLCs), etc.

Further, device 2500 should not be interpreted as having any dependency relating to one or a combination of components illustrated in device 2500. For example, device 2500 may include one or more computers, such as a laptop computer, a desktop computer, a mainframe computer, etc., or any combination or accumulation thereof.

Device 2500 can also include a bus 2508 configured to allow various components and devices, such as processors 2502, memory 2504, and local data storage 2510, among other components, to communicate with each other.

Bus 2508 can include one or more of any of several types of bus structures, including a memory bus or memory controller, a peripheral bus, an accelerated graphics port, and a processor or local bus using any of a variety of bus architectures. Bus 2508 can also include wired and/or wireless buses.

Local data storage 2510 can include fixed media (e.g., RAM, ROM, a fixed hard drive, etc.) as well as removable media (e.g., a flash memory drive, a removable hard drive, optical disks, magnetic disks, and so forth).

One or more input/output (I/O) device(s) 2512 may also communicate via a user interface (UI) controller 2514, which may connect with I/O device(s) 2512 either directly or through bus 2508.

In one possible implementation, a network interface 2516 may communicate outside of device 2500 via a connected network.

A media drive/interface 2518 can accept removable tangible media 2520, such as flash drives, optical disks, removable hard drives, software products, etc. In one possible implementation, logic, computing instructions, and/or software programs comprising elements of module 2506 may reside on removable media 2520 readable by media drive/interface 2518.

Various processes of the present disclosure or parts thereof can be implemented by instructions and/or software programs that are elements of module 2506. Such instructions and/or software programs may reside on removable media 2520 readable by media drive/interface 2518 as is well known in the computing arts.

In one possible embodiment, input/output device(s) 2512 can allow a user (such as a human annotator) to enter commands and information to device 2500, and also allow information to be presented to the user and/or other components or devices. Examples of input device(s) 2512 include, for example, sensors, a keyboard, a cursor control device (e.g., a mouse), a microphone, a scanner, and any other input devices known in the art. Examples of output devices include a display device (e.g., a monitor or projector), speakers, a printer, a network card, and so on.

Various processes or parts of the workflow of the present disclosure may be described herein in the general context of software or program modules, or the techniques and modules may be implemented in pure computing hardware. Software generally includes routines, programs, objects, components, data structures, and so forth that perform particular tasks or implement particular abstract data types. An implementation of these modules and techniques may be stored on or transmitted across some form of tangible computer-readable media. Computer-readable media can be any available data storage medium or media that is tangible and can be accessed by a computing device. Computer readable media may thus comprise computer storage media. “Computer storage media” designates tangible media, and includes volatile and non-volatile, removable and non-removable tangible media implemented for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information, and which can be accessed by a computer.

In embodiments, any one or any portion or all of the steps or operations of the workflow as described above can be performed by a processor. The term “processor” should not be construed to limit the embodiments disclosed herein to any particular device type or system. The processor may include a computer system. The computer system may also include a computer processor (e.g., a microprocessor, microcontroller, digital signal processor, or general purpose computer) for executing any of the methods and processes described above.

The computer system may further include a memory such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

Some of the methods and processes described above, can be implemented as computer program logic for use with the computer processor. The computer program logic may be embodied in various forms, including a source code form or a computer executable form. Source code may include a series of computer program instructions in a variety of programming languages (e.g., an object code, an assembly language, or a high-level language such as C, C++, or JAVA). Such computer instructions can be stored in a non-transitory computer readable medium (e.g., memory) and executed by the computer processor. The computer instructions may be distributed in any form as a removable storage medium with accompanying printed or electronic documentation (e.g., shrink wrapped software), preloaded with a computer system (e.g., on system ROM or fixed disk), or distributed from a server or electronic bulletin board over a communication system (e.g., the Internet or World Wide Web).

Alternatively or additionally, the processor may include discrete electronic components coupled to a printed circuit board, integrated circuitry (e.g., Application Specific Integrated Circuits (ASIC)), and/or programmable logic devices (e.g., a Field Programmable Gate Arrays (FPGA)). Any of the methods and processes described above can be implemented using such logic devices.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims. Moreover, embodiments described herein may be practiced in the absence of any element that is not specifically disclosed herein.

In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

There have been described and illustrated herein one or more embodiments of methods and systems that estimate formation water saturation and CEC based on resistivity log data. It will therefore be appreciated by those skilled in the art that yet other modifications could be made to the provided invention without deviating from its spirit and scope as claimed.

What is claimed is:

1. A method of characterizing a subterranean formation, comprising:
obtaining resistivity log data measured by a logging-while-drilling electromagnetic tool operated while drilling a wellbore that traverses the subterranean formation; and
calculating at least one of a first data value representing water saturation of the subterranean formation and a second data value representing cation exchange capacity (CEC) of the subterranean formation from the resistivity log data.

2. A method according to claim 1, further comprising:
storing at least one of the first data value and the second data value in computer memory.

3. A method according to claim 1, further comprising:
outputting at least one of the first data value and the second data value as part of a log for well placement, formation evaluation, geological modeling, or reservoir management.

4. A method according to claim 1, further comprising:
using at least one of the first data value and the second data value for geo-steering the drilling of the wellbore.

5. A method according to claim 1, wherein:
the first data value representing water saturation of the subterranean formation is calculated using a relationship involving an in-phase conductivity component, a quadrature-phase conductivity component, and a first plurality of formation parameters; and
the in-phase conductivity component and the quadrature-phase conductivity component are determined by inversion of the resistivity log data measured by the logging-while-drilling electromagnetic tool.

6. A method according to claim 5, wherein:
the first plurality of formation parameters comprises water conductivity.

7. A method according to claim 6, wherein:
said water conductivity is calculated using water salinity and formation temperature.

8. A method according to claim 7, wherein:
said water salinity and formation temperature are determined using at least one formation water sample.

9. A method according to claim 5, wherein:
the first plurality of formation parameters further comprise an electric formation factor and a parameter based on grain density, counter-ion mobility, and fraction of counter-ion.

10. A method according to claim 9, wherein:
the first plurality of formation parameters further comprise an additional parameter based on grain density, counter-ion mobility, and electric formation factor.

11. A method according to claim 1, wherein:
the second data value representing CEC of the subterranean formation is calculated using a relationship involving a quadrature-phase conductivity component, the first data value representing water saturation of the subterranean formation, and a second plurality of formation parameters; and
the quadrature-phase conductivity component is determined by inversion of the resistivity log data measured by the logging-while-drilling electromagnetic tool.

12. A method according to claim 11, wherein:
the second plurality of formation parameters comprise a parameter based on grain density, counter-ion mobility and fraction of counter-ion.

13. A method according to claim 1, wherein:
the calculating of the at least one of the first data value and the second data value is based on knowledge about the subterranean formation obtained from laboratory measurements and/or measurement logs.

14. A method according to claim 1, wherein:
the subterranean formation comprises clay.

15. A method according to claim 14, wherein:
the subterranean formation comprises a shaly-sand formation.

16. A method according to claim 1, wherein:
the resistivity log data comprises attenuation and phase-shift measurements performed by the logging-while-drilling electromagnetic tool.

17. A method according to claim 16, wherein:
the attenuation and phase-shift measurements are performed at frequencies in the KHz to MHz range.

18. A method according to claim 1, wherein:
the logging-while-drilling electromagnetic tool is part of a bottom hole assembly that includes a rotary drill bit.

19. A method according to claim 1, wherein:
the logging-while-drilling electromagnetic tool comprises a propagation type resistivity tool.

20. A method according to claim 1, wherein:
the resistivity log data is obtained at different depths in the wellbore in order to investigate different parts of the subterranean formation that is traversed by the wellbore while drilling the wellbore.

21. A method according to claim 20, further comprising:
processing the resistivity log data at respective depths in order to calculate at least one of the first data value and the second data value at the different depths.
